(19) United States
(12) Patent Application Publication
(10) Pub. No.: US 2004/0004606 A1
(43) Pub. Date: Jan. 8, 2004

(54) Image display element and image display device

(75) Inventors: Manabu Kodate, Shiga (JP); Tatsuya Yata, Shiga (JP); Hiroshi Nakashima, Shiga (JP); Midori Suzuki, Shiga (JP)

Correspondence Address: FOLEY AND LARDNER, SUITE 500, 3000 K STREET NW, WASHINGTON, DC, 20007, US

(73) Assignee: CHI MEI OPTOELECTRONICS CORP.

(21) Appl. No.: 10/609,384

(22) Filed: Jul. 1, 2003

(30) Foreign Application Priority Data
Jul. 5, 2002 (JP) 2002-197848

(51) Int. Cl. G09G 5/00

(52) U.S. Cl. 345/204

(57) ABSTRACT

An image display element includes a plurality of data lines that supply display signals and a plurality of scan lines that supply scan signals. A first pixel electrode and a second pixel electrode are supplied with display signals from a common data line. A first electrostatic shielding unit shields the first pixel electrode from an electric field produced by a data line that is adjacent to the first pixel electrode and a second electrostatic shielding unit shields the second pixel electrode from an electric field produced by a data line that is adjacent to the second pixel electrode.

### BACKGROUND OF THE INVENTION

1) Field of the Invention

The present invention relates to an image display element and an image display device having improved image display characteristics.

2) Description of the Related Art

One of the reasons the liquid-crystal displays are becoming popular is that the liquid-crystal displays have a better resolution than the cathode ray-tube (CRT) displays. One approach in the liquid-crystal displays is to use an active matrix system comprising TFTs (Thin Film Transistors) as switching devices.

Such liquid-crystal displays has scan lines and data lines disposed in a matrix. Thin film transistors are disposed at intersection points of the matrix to provide a TFT array substrate. A counter substrate that is disposed opposite to the TFT array substrate at a predetermined distance. A liquid crystal material is sealed in a space between the TFT array substrate and the counter substrate. The TFTs control voltages applied to the liquid crystal material based on the data to be displayed. Thus, the data is displayed by utilizing the electro-optic effect of the liquid crystal. The thin-film transistors are turned ON and OFF based on potentials given from the scan lines and the data lines that are connected to the driving circuit respectively.

In the liquid-crystal displays, there is a trend of increase in the number of pixels, and in turn, in the numbers of data lines and scan lines. The number of driving integrated circuits is also in the increasing trend. This trend, however, brings about an increase in manufacturing cost and aggravation of productivity. Therefore, there has been proposed a structure (hereinafter, “multiplexed image structure”) in which one data line gives potentials to a plurality of pixel electrodes in time division. This makes it possible to decreases the number of data lines and the number of the driving integrated circuits that are connected to the data lines.

FIG. 14 is an equivalent circuit diagram of TFT array substrates in a liquid-crystal display that employs the multiplexed image structure. A pixel electrode A1 is connected to a scan line Gₙ₊₁ and a scan line Gₙ₊₂ via a first thin-film transistor M1 and a second thin-film transistor M2. The pixel electrode A1 receives a display signal from a data line Dₘ. A pixel electrode B1 is connected to the scan line Gₙ₊₁ via a third thin-film transistor M3. The pixel electrode B1 receives a display signal from the data line Dₘ. For examples pixel electrodes C1, and D1 are also connected in the manner as the pixel electrodes A1 and B1. Since such a structure requires a lesser number of data lines driving integrated circuits, it becomes possible to lower the manufacturing cost and improve the productivity.

Conventional liquid-crystal displays that employ a multiplexed image structure are disclosed in, for example, Japanese Patent Application Laid-open Publication No. 6-148680, Japanese Patent Application Laid-open Publication No. 11-2837, Japanese Patent Application Laid-open Publication No. 5-265045, Japanese Patent Application Laid-open Publication No. 5-188395, and Japanese Patent Application Laid-open Publication No. 5-303114.

However, the inventors of the present application discovered that the liquid-crystal display with the conventional multiplexed image structure has lower screen quality than a liquid-crystal display that supplies a potential to a single pixel electrode group based on a single data line.

Specifically, the inventors discovered that when data lines extend in a vertical direction, a striped pattern in a vertical direction is displayed in a lateral direction in a specific cycle. This problem of screen display quality is not so noticeable when many images are displayed, however, it becomes remarkable when a halftone of the same intermediate color is displayed in a wide area of the screen.

A color liquid-crystal display displays the image by using pixel electrodes that display three colors of R (read), G (green), and B (blue). An electrode and a switching device are provided for each color. The electrode and the switching device are collectively referred to as a “pixel” and the electrode is referred to as “pixel electrode”. A predetermined potential is supplied to each pixel electrode so as to display a predetermined color.

If one color is to be displayed on many pixels, then same signals are supplied to the data lines and the scan lines corresponding to those pixels. However, even if same signal is supplied to a group of pixels, sometimes these pixels do not display the same color. In that case, a striped pattern in a vertical direction is produced. In other words, in terms of pixel electrodes, one pattern comprises six pixel electrodes laid out in a lateral direction, and such patterns continue in the lateral direction.

It was not known earlier that such a problem exists. This was because of two major reasons. First, this problem arises in only those liquid-crystal displays that have the multiplexed image structure. Second, the liquid-crystal displays that have the multiplexed image structure were not put into practical use before the filling of application of the present invention.

### SUMMARY OF THE INVENTION

It is an object of the present invention to at least solve the problems in the conventional technology.

An image display element according to one aspect of the present invention includes a plurality of data lines that supply display signals and a plurality of scan lines that supply scan signals. A first pixel electrode and a second pixel electrode are supplied with display signals from a common data line. A first electrostatic shielding unit shields the first pixel electrode from an electric field produced by a data line that is adjacent to the first pixel electrode and a second electrostatic shielding unit shields the second pixel electrode from an electric field produced by a data line that is adjacent to the second pixel electrode.

An image display device according to another aspect of the present invention includes an image display unit having pixels laid out in a matrix shape of M times N, where M and N are arbitrary natural numbers. The image display device also includes a data line driving circuit that supplies a display signal to a plurality of data lines and a scan line driving circuit that supplies a scan signal to a plurality of scan lines. A first pixel electrode and a second pixel electrode are supplied with display signals from a common data line. A first electrostatic shielding unit shields the first pixel electrode from an electric field produced by a data line that is adjacent to the first pixel electrode and a second electrostatic shielding unit shields the second pixel electrode from an electric field produced by a data line that is adjacent to the second pixel electrode.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a schematic view of a structure of a TFT array substrate in a liquid-crystal display according to a first embodiment of the present invention;

FIG. 2 is a top plan view of an actual wiring structure of a part of pixel electrodes that form a display area on the TFT array substrate and the surrounding of the pixel electrodes;

FIG. 3 is a cross-sectional view of the wiring structure cut along a line A-A of the structure shown in FIG. 2;

FIG. 4 shows an equivalent circuit of the wiring structure in the display area on the TFT array substrate;

FIG. 5 is a timing chart that shows a basic operation of the liquid-crystal display according to the first embodiment;

FIG. 6 is a timing chart that shows a state that a potential supplied to each data line is different on the liquid-crystal display according to the first embodiment;

FIG. 7 is a schematic view that explains about the operation of an electrostatic shielding layer in the first embodiment;

FIG. 8 is a top plan view of a part of an actual wiring structure in a first modification of the liquid-crystal display according to the first embodiment;

FIG. 9A is a cross-sectional view of the wiring structure cut along a line B-B of the structure shown in FIG. 8, and FIG. 9B is a cross-sectional view of the wiring structure cut along a line C-C of the structure shown in FIG. 8;

FIG. 10A shows a state that a positioning of a mask pattern is carried out completely in the first modification, and FIG. 10B shows a state that an error occurs in a positioning of a mask pattern;

FIG. 11 is a cross-sectional view of a structure of an electrostatic shielding layer in a second modification of the liquid-crystal display according to the first embodiment;

FIG. 12 is a top plan view of a part of actual wiring structures on a TFT array substrate that constitute an image display according to a second embodiment of the present invention;

FIG. 13 is a top plan view of a part of actual wiring structures on a TFT array substrate that constitutes an image display in a modification of the image display according to the second embodiment; and

FIG. 14 shows an equivalent circuit of a TFT array substrate in a liquid-crystal display that has a multiplexed image structure according to a conventional technique.

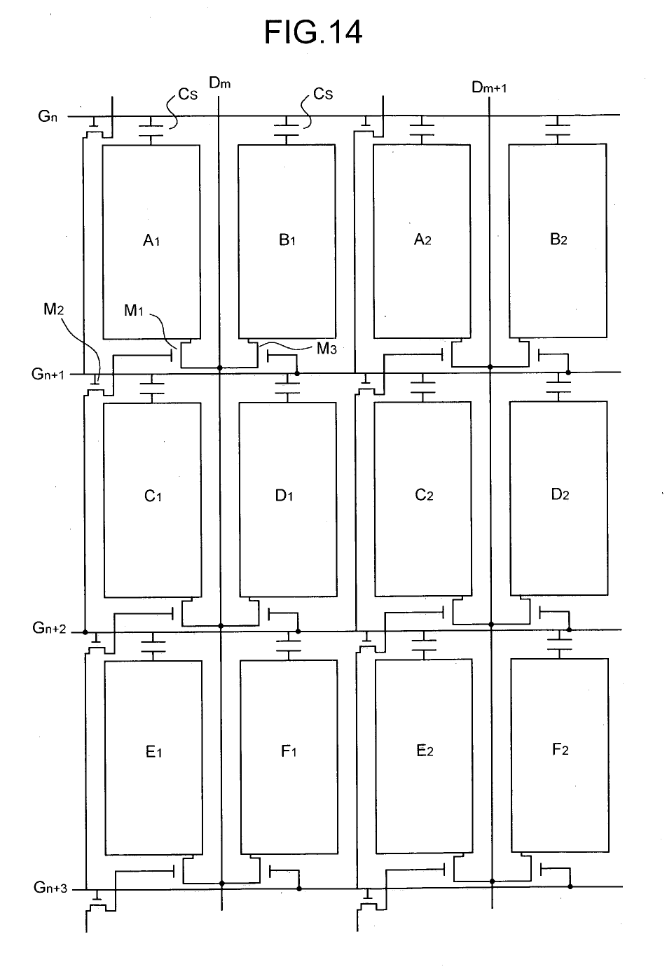

### DETAILED DESCRIPTION

Exemplary embodiments of the image display element and an image display device according to the present invention will be explained below with reference to the accompanying drawings. In the drawings, identical or like portions are attached with identical or like reference symbols or numerals. It should be noted that the drawings are schematic views, and they do not exactly show real portions. It is needless to mention that the drawings include portions that have different size relations or ratios between the drawings.

The liquid-crystal display according to a first embodiment has TFT array substrate with pixel electrodes and metal layers that shield an electric field in an area between a pixel electrode and a data line adjacent to the pixel electrode. A liquid-crystal display apparatus generally includes devices such as a counter substrate that is disposed to face the TFT array substrate, and a back light unit. However, since these devices are not characteristic parts of the present invention, the explanation of these parts will be omitted.

It is needless to mention that it is possible to broadly apply the present invention to any liquid-crystal display with the multiplexed image structure. Moreover, the thin-film transistor is a switching device that has three terminals. When the thin-film transistor is used for a liquid-crystal display, the source electrode is connected to the data line, and the drain electrode is connected to the pixel electrode. However, the source electrode may even be connected to the pixel electrode, and the drain electrode may even be connected to the data line. In the following description, the two terminals excluding the gate electrode of the thin-film transistor will be called source/drain electrodes.

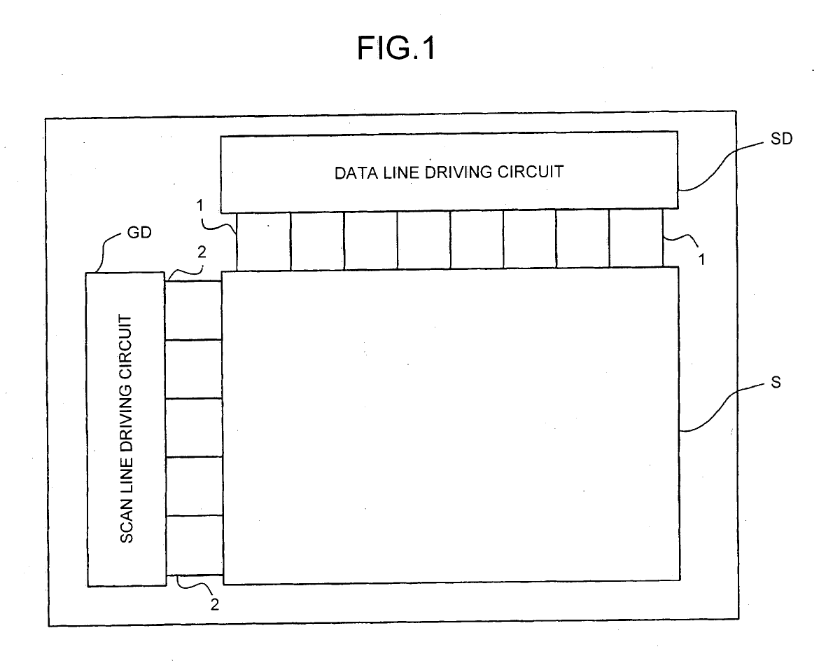

FIG. 1 is a top plan view of a structure of a TFT array substrate. The TFT array substrate includes a data line driving circuit SD and a scan line driving circuit GD. The data line driving circuit SD supplies a display signal, or a voltage, to pixel electrodes disposed within a display area S via data lines 1. The scan line driving circuit GD supplies an operation signal to control ON and OFF of thin-film transistors via the scan lines 2. Pixels are disposed in a matrix form by a number of M times N (where M and N represent arbitrary positive integers) in the display area S.

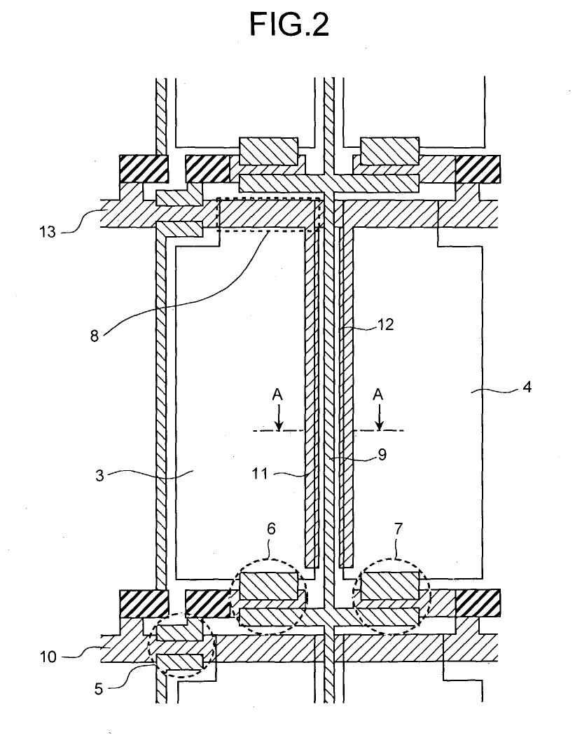

FIG. 2 is a top plan view of a layout of pixel electrodes and circuit devices that are connected to the pixel electrodes within the display area S on a TFT array substrate. A pixel electrode 3 and a pixel electrode 4 are adjacently disposed to sandwich a data line 9 between a scan line 13 and a scan line 10.

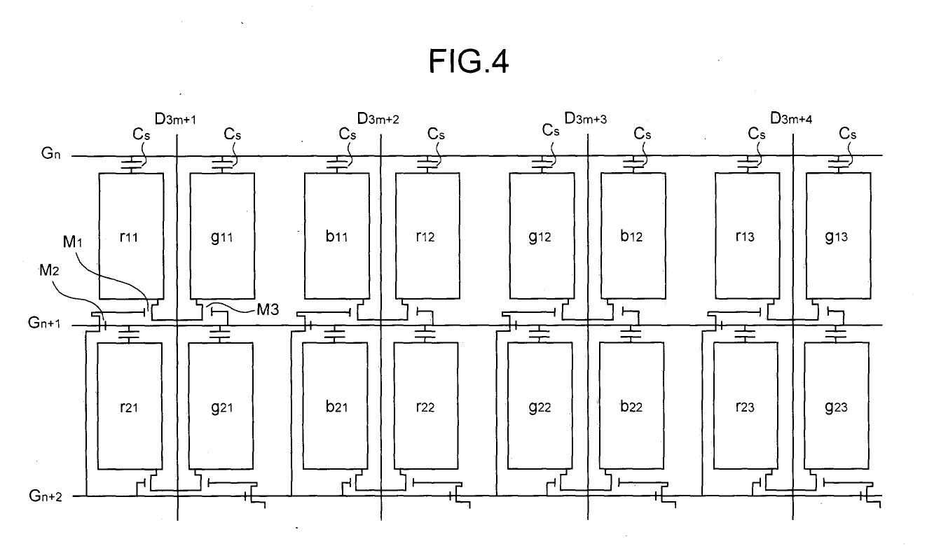

The pixel electrode 3 is connected to the source/drain electrode of a first thin-film transistor 6, and the gate electrode of the first thin-film transistor 6 is connected to the source/drain electrode of a second thin-film transistor 5. A pixel electrode 4 is connected to the source/drain electrode of a third thin-film transistor 7. The pixel electrodes 3 and 4 have an area respectively partially superimposed with a scan line 13 in a direction that is perpendicular to the surface of the layers (hereinafter, “layer direction”). The area of the pixel electrode 3 and the area of the scan line 3 that are superimposed with each other form a storage capacitor 8. An electric connection between the pixel electrodes 3 and 4, and thin-film transistors, data lines, and scan lines that are disposed around the pixel electrodes 3 and 4 will be explained in detail when an equivalent circuit shown in FIG. 4 is explained later.

Further, an electrostatic shielding layer 11 is disposed in an area near the pixel electrode 3 and the data line 9. An electrostatic shielding layer 12 is disposed in an area near the pixel electrode 4 and the data line 9. These electrostatic shielding layers 11 and 12 are connected to the scan line 13. This structure prevents or suppresses the influence of the electric field generated by the data line 9 on the pixel electrodes 3 and 4.

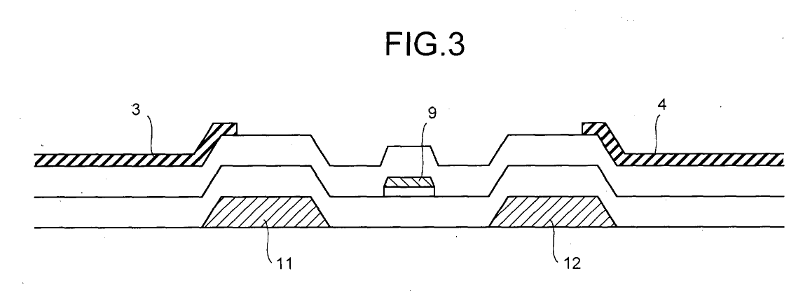

FIG. 3 is a cross-sectional view of the wiring structure cut along a line A-A of the structure shown in FIG. 2. The pixel electrodes 3 and 4 are disposed on the surface of the TFT array substrate. The data line 9 is disposed between the pixel electrodes 3 and 4 and at a lower level than the pixel electrodes 3 and 4. The electrostatic shielding layer 11 is disposed between the pixel electrode 3 and the data line 9 and at a lower level than the pixel electrode 3 and the data line 9. A part of the electrostatic shielding layer 11 is superimposed by the pixel electrode 3. A part of the electrostatic shielding layer 12 is superimposed by the pixel electrode 4.

The positions of the electrostatic shielding layers 11 and 12 are not limited to those shown in FIG. 2 and FIG. 3. As much as the electrostatic shielding layers 11 and 12 shield the pixel electrodes 3 and 4 from the electric field produced by the data line 9, the electrostatic shielding layers 11 and 12 may be disposed at any other positions. The electrostatic shielding layers 11 and 12 shown in FIG. 3 can be formed in the same process as that of the scan lines and the thin-film transistors in manufacturing the TFT array substrate. Therefore, the manufacturing process does not become complex in disposing the electrostatic shielding layers 11 and 12.

FIG. 4 illustrates an equivalent circuit of a wiring structure within the display area S. The wiring structure within the display area S has a plurality of scan lines and a plurality of data lines that are disposed in a matrix shape. In the area between the scan line Gₙ (where n is a positive integer) and the scan line Gₙ₊₁, there are disposed a pixel electrode r11 and a pixel electrode g11. A data line D₃ₘ₊₁ (where m is zero or a positive integer) is disposed between pixel electrode r11 and a pixel electrode g11. A data line D₃ₘ₊₂ is disposed between a pixel electrode b11 and a pixel electrode r12. A data line D₃ₘ₊₃ is disposed between a pixel electrode g12 and a pixel electrode b12. A data line D₃ₘ₊₄ is disposed between a pixel electrode r13 and a pixel electrode g13. Pixel electrodes r21 and g21 are provided at the latter stage of the pixel electrodes r11 and g11. The pixel electrodes r21 and g21 are disposed between the scan line Gₙ₊₁ and the scan line Gₙ₊₂. Pixel electrodes b21 and r22, pixel electrodes g22 and b22, and pixel electrodes r23 and g23 are disposed in the same manner as the pixel electrodes b11 and r12, the pixel electrodes g12 and b12, and the pixel electrodes r13 and g13. Every pixel electrode is connected to a data line and a scan line via a predetermined circuit device respectively. Taking the pixel electrode r11 as an example, the pixel electrode r11 is connected to one source/drain electrode of the thin-film transistor M1. The other source/drain electrode of the thin-film transistor M1 is connected to the data line D₃ₘ₊₁, and the gate electrode is connected to one source/drain electrode of the second thin-film transistor M2. The other source/drain electrode of the second thin-film transistor M2 is connected to the scan line Gₙ₊₂, and the gate electrode is connected to the scan line Gₙ₊₁. The pixel electrode r11 is also connected to the scan line Gₙ via a storage capacitor Cs.

The pixel electrode g11 is connected to one source/drain electrode of the third thin-film transistor M3. The other source/drain electrode of the third thin-film transistor M3 is connected to the data line D₃ₘ₊₁, and the gate electrode is connected to the scan line Gₙ₊₁. The pixel electrode g11 is connected to the scan line Gₙ via the storage capacitor Cs.

Regarding other electrode, the pixel electrodes disposed between the scan line Gₙ and the scan line Gₙ₊₁ have the following wiring structures. The pixel electrodes b11, g12, and r13 disposed at the left of the data lines D₃ₘ₊₂ to D₃ₘ₊₄ respectively form wiring structures with the surrounding scan lines and data lines that are equivalent to the wiring structure of the pixel electrode r11. The pixel electrodes r12, b12, and g13 disposed at the right of the data lines D₃ₘ₊₂ to D₃ₘ₊₄ form wiring structures with the surrounding scan lines and data lines that are equivalent to the wiring structure of the pixel electrode g11.

The pixel electrodes g21, r22, b22, and g23 disposed at the right of the data lines D₃ₘ₊₁ to D₃ₘ₊₄ are connected to predetermined data lines and scan lines via the first thin-film transistor and the second thin-film transistor disposed corresponding to the respective pixel electrodes, like the pixel electrode r11. The pixel electrodes r21, b21, g22, and r23 disposed at the left of the data lines D₃ₘ₊₁ to D₃ₘ₊₄ are connected to predetermined data lines and scan lines via the third thin-film transistor disposed corresponding to the respective pixel electrodes, like the pixel electrode g11. The rest of the pixel electrodes are similarly wired to the surrounding scan lines and data lines as shown in FIG. 4.

The functions of the electrostatic shielding layers 11 and 12 will be explained next. A basic mechanism of supplying a potential to a pixel electrode in the liquid-crystal display using a multiplexed pixel structure will be explained first. Then, a variation in the potential of each data line will be explained based on an example of a display of a halftone of the same intermediate color. Last, functions of the electrostatic shielding layers 11 and 12 will be explained.

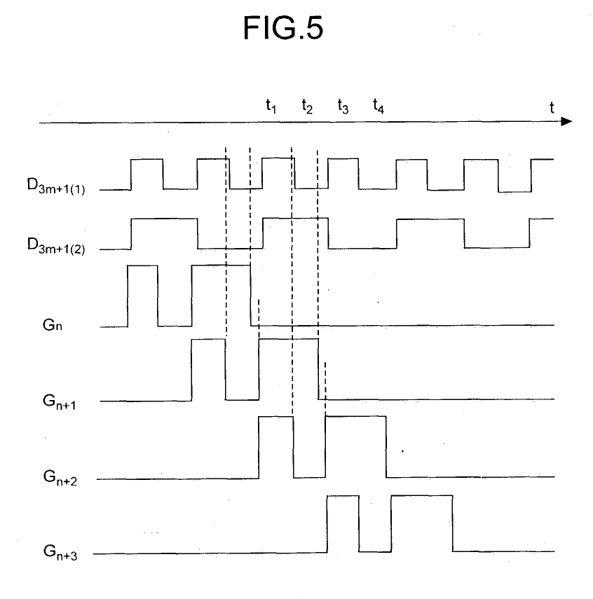

First, the mechanism of supplying a potential to a pixel electrode will be explained. FIG. 5 is a timing chart that shows a change in the potential that is supplied from each data line and each scan line. The following explanation is provided to enhance the understanding of a mechanism of supplying a potential to each pixel electrode. Therefore, the timing chart shown in FIG. 5 does not particularly show a change of gradation. In order to facilitate the understanding, only the pixel electrodes that are connected to the data line D₃ₘ₊₁ will be explained. It is needless to mention that the basic operation is also the same for the pixel electrodes that are connected to other data lines D₃ₘ₊₂ to D₃ₘ₊₄, and the pixel electrodes that are not shown in FIG. 4.

D₃ₘ₊₁ (1) and D₃ₘ₊₁ (2) in FIG. 5 represent represents timings when a potential or a polarity of a data signal supplied from the data line D₃ₘ₊₁ changes. Lines Gₙ to Gₙ₊₃ are illustrations of selection and non-selection of that scan line. Specifically, an elevation of the line illustrates that the scan line is selected, and the flat portion illustrates that the scan line Gₙ is not selected.

A period t1 starts from when both the scan line Gₙ₊₁ and the scan line Gₙ₊₂ are selected till when the scan line Gₙ₊₂ becomes non-selected. During this period t1, the first thin-film transistor M1 to the third thin-film transistor M3 are kept ON, and the data line D₃ₘ₊₁ outputs a potential V1a to supplied to the pixel electrode r11. Thus, the potential of the pixel electrode r11 is settled. After the scan line Gₙ₊₂ becomes non-selected, the potential output from the data line D₃ₘ₊₁ changes to V1b. When this potential is supplied to the pixel electrode g11, the potential of the pixel electrode g11 is settled.

A period t2 starts after the scan line Gₙ₊₂ becomes non-selected and ends when the scan line Gₙ₊₁ becomes non-selected. During the period t2, the scan line Gₙ₊₁ is selected so that the thin-film transistor M1 is turned OFF, and the thin-film transistor M3 is turned ON. Therefore, the data line D₃ₘ₊₁ stops supplying the potential to the pixel electrode r11, and continuously supplies the potential to the pixel electrode g11. Consequently, the potential of the pixel electrode g11 is settled.

A period t3 starts when the scan line Gₙ₊₁ becomes non-selected. During this period t3, a potential supplied from the data line D₃ₘ₊₁ changes to V1c, the scan line Gₙ₊₂ is selective again, and the scan line Gₙ₊₃ is selective. As a result, the data line D₃ₘ₊₁ supplies the potential V1c to the pixel electrode r21 and the pixel electrode g21, thereby to settle the potential of the pixel electrode g21. Thereafter, based on a sequential switching of scan lines that become at a selective potential and based on a switching of the potential of the data line D₃ₘ₊₁ corresponding to this switching, potentials of other pixel electrodes after the adjacent pixel electrode r21 sandwiching the data line D₃ₘ₊₁ and after are determined. As explained above, a suitable potentials is supplied based on a predetermined data line and a predetermined scan line. Based on this, for the pixel electrodes that are connected to the data line D₃ₘ₊₁, predetermined potentials are supplied to the pixel electrodes in the order of r11, g11, g21, and r21. This similarly applies to other pixel electrodes that are connected to other data lines. For the pixel electrodes that are connected to the data line D₃ₘ₊₂, potentials are supplied to the pixel electrodes in the order of b11, r12, r22, and b21. For the pixel electrodes that are connected to the data line D₃ₘ₊₃, potentials are supplied to the pixel electrodes in the order of g12, b12, b22, and g22. For the pixel electrodes that are connected to the data line D₃ₘ₊₄, potentials are supplied to the pixel electrodes in the order of r13, g13, g23, and r23.

Next, a potential variation of each data line when a halftone of the same intermediate color is displayed in the display area S will be explained. When a liquid-crystal display has a multiplexed image structure like the liquid-crystal display according to the first embodiment, a timing chart of a supplied potential is different for each data line even when a halftone of the same intermediate color is to be displayed in each pixel. The fact that the timing chart is different for each data line will be explained below by taking an example that a halftone yellow is displayed over the total display area S.

In order to display a halftone yellow in each pixel, it is necessary to display R and G in a halftone and set B to a non-display state among the elements that constitute a pixel. Therefore, in the case of a normally white mode, for example, it is necessary to supply potentials to the pixel electrodes that constitute each pixel as follows. In order to set B to a non-display state, it is necessary to supply a rated potential, which makes a transmissivity to zero, to the pixel electrodes b11 to b22. In order to display R and G in a halftone, it is necessary to supply a potential of about a half of a rated potential to the pixel electrodes r11 to r23 and the pixel electrodes g11 to g23, for example.

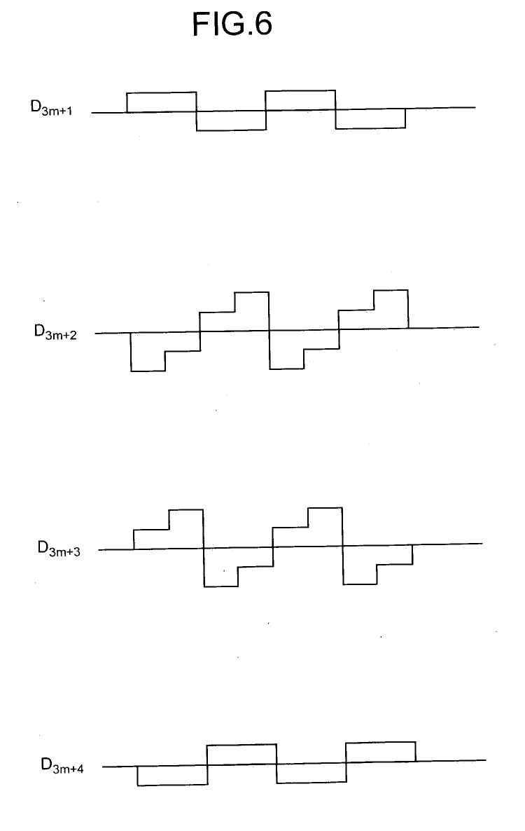

FIG. 6 are timing charts of potential variations of the data lines D₃ₘ₊₁ to D₃ₘ₊₄ when a halftone yellow is displayed in the total display area. The data line D₃ₘ₊₁ that supplies potentials to the pixel electrodes r11 and r21 and the pixel electrodes g11 and g21 does not need to change absolute values of the potentials each time when a pixel electrode is switched. Therefore, the timing chart becomes uniform except a change in the polarity. On the other hand, the data line D₃ₘ₊₂ needs to supply a rated potential to the pixel electrodes b11 and b21, and supply a potential which is a half of the rated potential to the pixel electrodes r12 and r22. Therefore, the data line D₃ₘ₊₂ needs to change the supplied potential, each time when a pixel electrode supplied with the potential changes from the pixel electrode b11 to the pixel electrode r12, and each time when a pixel electrode supplied with the potential changes from the pixel electrode r22 to the pixel electrode b21. When a change in the polarity is included, the timing chart becomes different from that of the data line D₃ₘ₊₁ as shown in FIG. 6.

The timing chart of the data line D₃ₘ₊₃ also becomes different from that of the data line D₃ₘ₊₁. Specifically, the data line D₃ₘ₊₃ needs to supply potentials to the pixel electrodes g12 and g22 and the pixel electrodes b12 and b22. The data line D₃ₘ₊₃ supplies a potential of a half of a rated potential to the pixel electrodes g12 and g22, and supplies the rated potential to the pixel electrodes b12 and b22. Therefore, the data line D₃ₘ₊₃ needs to change a supplied potential, each time when a pixel electrode supplied with a potential changes from the pixel electrode g12 to the pixel electrode b12, and each time when a pixel electrode supplied with a potential changes from the pixel electrode b22 to the pixel electrode g22. When a change in the polarity is included, the timing chart becomes as shown in FIG. 6. The data line D₃ₘ₊₄ supplies a potential, which is a half of a rated potential, to the pixel electrodes r13 and r23 and the pixel electrodes g13 and g23. Therefore, when a change in the polarity is excluded, the timing chart becomes uniform like that of the data line D₃ₘ₊₁. As explained above, when a potential supplied from a data line is looked at, the timing chart of the data line D₃ₘ₊₁ and the timing charts of the data lines D₃ₘ₊₂ and D₃ₘ₊₃ become different from each other, despite the fact that the same color is displayed in the total display area S. On the other hand, as shown in FIG. 4, the data line D₃ₘ₊₁ and the data line D₃ₘ₊₄ supply a constant potential to the connected pixel electrodes. Therefore, the timing charts of these data lines become equivalent, although the polarities become opposite. In other words, it is clear that the timing charts of the potentials supplied from the data lines change with three data lines as one period.

As is clear from the actual wiring structures shown in FIG. 2 and FIG. 3, from the viewpoint of increasing the aperture ratio, a pixel electrode and a data line are disposed extremely close to each other. Therefore, when only a dielectric exists between a pixel electrode and a data line, the potential of the pixel electrode receives an influence of a potential variation of the data line. For example, the pixel electrode r11 and the pixel electrode r12 receive different influences from the connected data line D₃ₘ₊₁ and data line D₃ₘ₊₂ respectively, because the timing charts of these data lines are different. Therefore, the pixel electrode r11 and the pixel electrode r12 have a fine difference between the effective potentials, although these pixel electrodes are basically supplied with a potential of the same gradation. For a similar reason, there is a fine difference between the effective potentials of the pixel electrode g11 and the pixel electrode g12 respectively. Therefore, a fine difference occurs between the colors displayed from the pixels to which the respective pixel electrodes belong. On the other hand, the timing charts of the potentials of the data line D₃ₘ₊₁ and the data line D₃ₘ₊₄ become similar. Therefore, the pixel electrode r11 and the pixel electrode r13, and the pixel electrode g11 and the pixel electrode g13 receive equivalent influences from the respective data lines. The colors displayed in the pixels to which the respective pixel electrodes belong become similar. Therefore, when it is not possible to avoid the influences of variations in the potentials of the data lines, considering in a pixel unit, a striped pattern is generated with two pixels as one period. Considering in a pixel electrode unit, a striped pattern is generated with six pixel electrodes as one period. The inventors of the present application find that the period the striped pattern actually observed in the conventional liquid-crystal display and the period the above pixel electrodes coincides with each other, and confirm that the striped pattern is generated for the above reasons.

The liquid-crystal display according to the first embodiment includes the electrostatic shielding layers 11 and 12 that eliminate the influence of data lines applied to the pixel electrodes and suppress the generation of the striped pattern. The striped pattern is generated due to the influence of the potential variation of the data line applied to the pixel electrode. Therefore, in order to suppress the generation of the striped pattern, it is necessary to cancel the electrical relationship between the data line and the pixel electrode. For this reason, in the first embodiment, the electrostatic shielding layer that shields the electric field generated from the pixel electrode is provided in the vicinity of the pixel electrode.

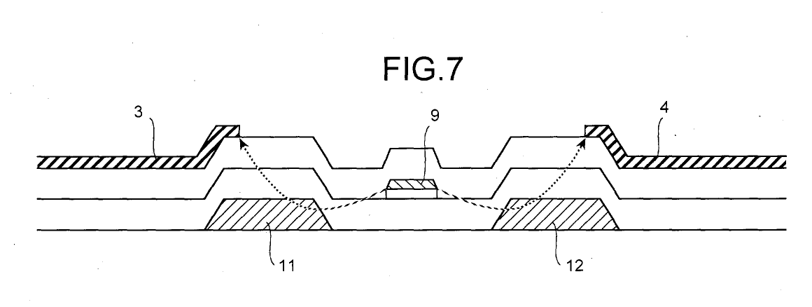

Functions of the electrostatic shielding layers 11 and 12 will be explained With reference to FIG. 7. The electrostatic shielding layers 11 and 12 are disposed in the lower layer as compared to that of the pixel electrodes 3 and 4, moreover, parts of the electrostatic shielding layers 11 and 12 are superimposed by the pixel electrodes 3 and 4 respectively. The electrostatic shielding layers 11 and 12 are connected to the scan line 13 (see FIG. 2).

The electrostatic shielding layers 11 and 12 shield the pixel electrodes 3 and 4 from the electric field (see broken line arrows). As a result, as compared with the conventional liquid-crystal display apparatus, it is possible to reduce the influence of the electric field produced by the data line 9 on the pixel electrodes 3 and 4. As the electrostatic shielding layers 11 and 12 are disposed in connection to the scan line 13, the electrostatic shielding layers 11 and 12 have a predetermined potential, and are disposed closer to the pixel electrodes 3 and 4 than to the data line 9. Therefore, the electric field generated from the electrostatic shielding layers 11 and 12 in the area where the pixel electrodes 3 and 4 are disposed becomes larger than the electric field generated from the data line 9. As a result, it is possible to eliminate the influence of the data line 9 applied to the pixel electrodes 3 and 4, even when the data line 9 is not completely isolated from the pixel electrodes 3 and 4 with the electrostatic shielding layers.

In the first embodiment, the electrostatic shielding layers that are disposed near the pixel electrodes disposed in the display area S are connected to predetermined scan lines. Each scan line maintains substantially a constant potential during a period except when the scan line controls ON and OFF of the thin-film transistor. Therefore, the electrostatic shielding layers disposed near the pixel electrodes have substantially an equivalent potential, and give substantially a constant influence to the pixel electrodes. Consequently, there occurs no difference in colors that are displayed in the pixels, and it becomes possible to suppress a generation of a striped pattern, which makes it possible to display a high-definition image. The inventors of the present application prepared a liquid-crystal display using a TFT array substrate that has structures shown in FIG. 1 to FIG. 4, and investigated in detail presence or absence of a generation of a striped pattern. As a result of the investigation, the inventors do not find a striped pattern that is observed conventionally, and obtain a screen display quality with no practicable problem.

In the liquid-crystal display according to the first embodiment, the electrostatic shielding layers 11 and 12 are formed in the same process as that of the formation of the scan line 13 and the gate electrode of the first thin-film transistor 6. Therefore, it is possible to avoid an increase in the number of manufacturing steps due to the provision of the electrostatic shielding layers 11 and 12, and it becomes possible to avoid an increase in the manufacturing cost. Therefore, the liquid-crystal display according to the first embodiment also has an advantage that it is possible to suppress degradation of the image definition while avoiding an increase in the manufacturing cost.

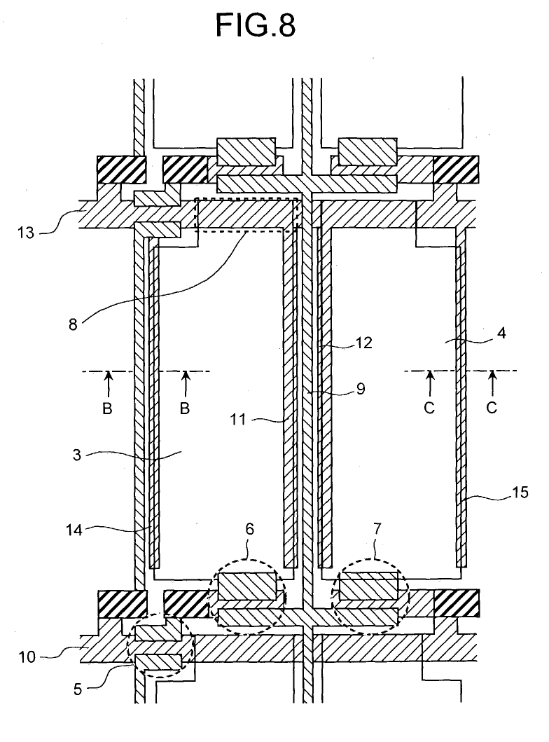

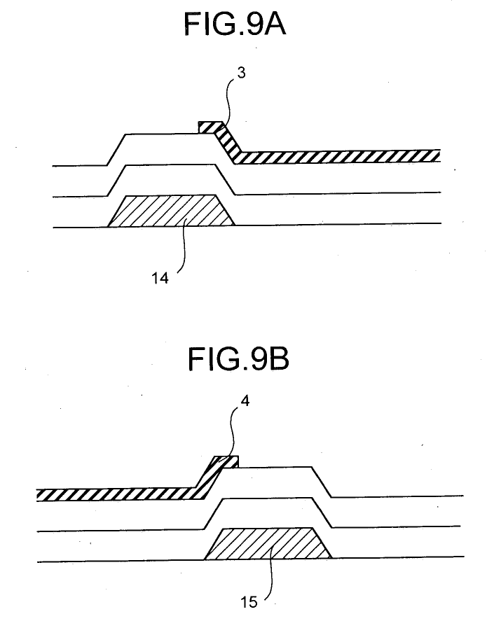

A modification of the liquid-crystal display according to the first embodiment will be explained now. FIG. 8 is a top plan view of an actual wiring structure on a TFT array substrate of the liquid-crystal display according to the first modification. The electrostatic shielding layers 11 and 12 are disposed like in the liquid-crystal display according to the first embodiment. On the other hand, there are provided capacitor lines 14 and 15 that are disposed in a lower layer as compared to the pixel electrodes 3 and 4 at their ends respectively so that the capacitor lines 14 and 15 face the electrostatic shielding layers 11 and 12 respectively and are also brought into contact with the scan line 13. FIG. 9A is a cross-sectional view of the wiring structure cut along a line B-B of the structure shown in FIG. 8, and FIG. 9B is a cross-sectional view of the wiring structure cut along a line C-C of the structure shown in FIG. 8. As seen in FIG. 9A, the capacitor line 14 is disposed on the lower layer of the pixel electrode 3 at its end, and has a part of the area superimposed with the pixel electrode 3 in the layer direction. As shown in FIG. 9B, the capacitor line 15 is also disposed on the lower layer of the pixel electrode 4 at its end, and has a part of the area superimposed with the pixel electrode 4 in the layer direction.

Thus, the electrostatic shielding layers 11 and 12 are disposed so that the electrostatic shielding layers are partially superimposed with the pixel electrodes 3 and 4 in the layer direction respectively. The electrostatic shielding layers 11 and 12 are connected to the scan line 13. Therefore, like the storage capacitor 8 shown in FIG. 2, a new storage capacitor is formed between the electrostatic shielding layer 11 and the pixel electrode 3 and between the electrostatic shielding layer 12 and the pixel electrode 4 respectively.

The wiring structures of the electrostatic shielding layers 11 and 12 and the pixel electrodes 3 and 4 are formed by repeating a formation of a predetermined metal layer film on a transparent substrate like glass and an etching of the film based on a mask pattern. When an error occurs in the positioning of the mask pattern, a superimposed area between the electrostatic shielding layer 11 and the pixel electrode 3 and a superimposed area between the electrostatic shielding layer 12 and the pixel electrode 4 may be different, so that new storage capacitors may be different, for example. When the storage capacitor formed with the pixel electrode 3 and the storage capacitor formed with the pixel electrode 4 are different, the influences that the storage capacitors give to the pixel electrodes 3 and 4 are also different. Therefore, the screen display quality is degraded despite the fact that the influence of a potential variation of the data line 9 is eliminated.

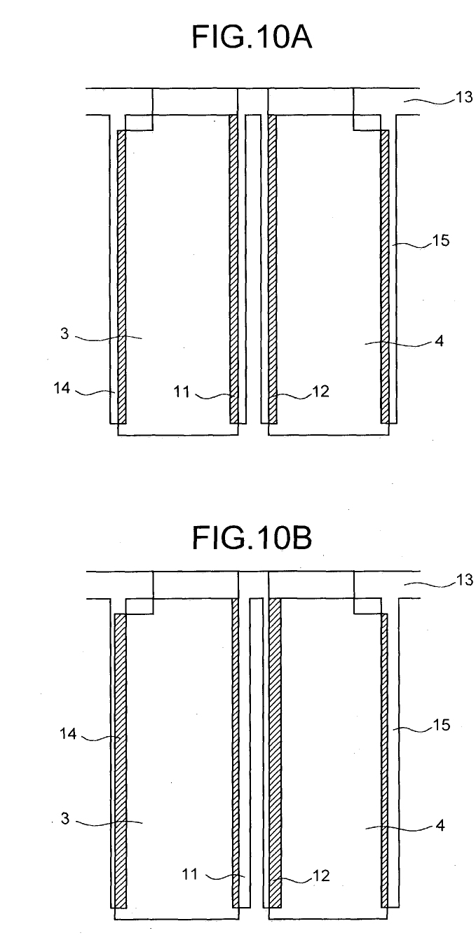

Therefore, in the liquid-crystal display according to the first modification, the capacitor lines 14 and 15 are connected to the electrostatic shielding layers 11 and 12 via the scan line 13. Consequently, even if an error occurs in the positioning of the mask pattern, it is possible to keep the storage capacitors at substantially a constant level. FIG. 10A and FIG. 10B show schematic structures of a detailed example. FIG. 10A is an illustration of a case when positioning of a mask pattern is carried out exactly as in the design, and FIG. 10B illustrates a case in which the electrostatic shielding layers 11 and 12 and the capacitor lines 14 and 15 are formed on a position deviated little on the right side of the designed position.

When the pixel electrode 3 in FIG. 10B is considered, for example, the overlap of the pixel electrode 3 and the electrostatic shielding layer 11 is smaller than that of the case of FIG. 10A. However, the overlap of the pixel electrode 3 and the capacitor line 14 is larger than that in the case of FIG. 10A, which indicates that this superimposed area compensates for a reduction in the superimposed area of the electrostatic shielding layer 11. Therefore, even when a slight error occurs in the positioning of the mask pattern, the total area of the superimposition between the pixel electrode 3 and the electrostatic shielding layer 11 and the superimposition between the pixel electrode 3 and the capacitor line 14 is maintained at substantially a constant level, so that the storage capacitor is also held at substantially a constant level. This similarly applies to the pixel electrode 4. In other words, the total area of the superimposition between the pixel electrode 4 and the electrostatic shielding layer 12 and the superimposition between the pixel electrode 4 and the capacitor line 14 is maintained at substantially a constant level.

Another modification of the liquid-crystal display according to the first embodiment will be explained next. In the liquid-crystal display according to the first embodiment, the electrostatic shielding layers 11 and 12 are provided corresponding to the pixel electrodes 3 and 4 respectively. In the second modification, an electrostatic shielding layer is integrally provided around the data line 9.

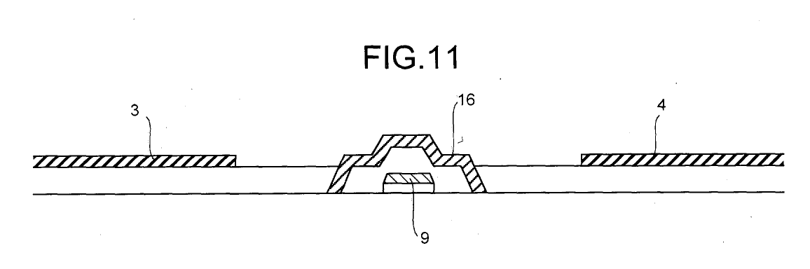

FIG. 11 is a cross-section of TFT array substrate around the data line 9. An electrostatic shielding layer 16 is disposed to surround the data line 9, thereby to completely shield the electric field that is generated from the data line 9. Therefore, the pixel electrodes 3 and 4 can completely eliminate the influence of a potential variation of the data line 9. As a result, it is possible to prevent the generation of a striped pattern in a screen display.

While it is possible to suppress degradation of the screen display quality by employing the above structure, it is also possible to suppress the striped pattern to an unobservable level with the electrostatic shielding layers 11 and 12 according to the first embodiment as explained above. Therefore, it is needless to mention that the structure of the liquid-crystal display according to the first embodiment is not denied.

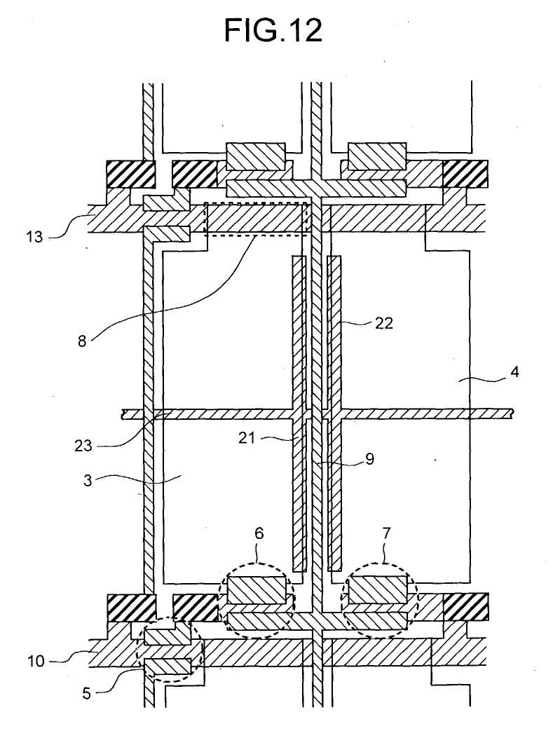

A liquid-crystal display according to a second embodiment of the present invention will be explained next. FIG. 12 is a top plan view of a part of a TFT array substrate in a liquid-crystal display according to the second embodiment. In FIG. 12, elements that are equivalent to those in FIG. 2 are attached with the same reference numerals as those in FIG. 2. Except where particularly specified, the liquid-crystal display has a similar structure and similar functions to those of the first embodiment. In the following explanation, the wiring structured of the total TFT array substrates that constitute the liquid-crystal display according to the second embodiment are similar to, those shown in FIG. 1 and FIG. 4. However, like in the first embodiment, the application of the present invention is not limited to the liquid-crystal display that has the structures shown in FIG. 1 and FIG. 4.

In the liquid-crystal display according to the second embodiment, electrostatic shielding layers 21 and 22 are not connected to the scan line 13, but are connected to a potential supply line 23 separately provided. Therefore, the electrostatic shielding layers 21 and 22 have potentials that are supplied from the potential supply line 23.

In the liquid-crystal display according to the second embodiment, based on the provision of the electrostatic shielding layers 21 and 22, it is possible to suppress degradation of the screen display quality due to a display of a vertical striped pattern in the image display, like in the liquid-crystal display according to the first embodiment. In addition to this, the liquid-crystal display according to the second embodiment has the following advantages. As is clear from FIG. 12, the electrostatic shielding layers 21 and 22 are disposed near the ends of the pixel electrodes 3 and 4 respectively. Therefore, a storage capacitor is generated between the electrostatic shielding layer 21 and the pixel electrode 3 and between the electrostatic shielding layer 22 and the pixel electrode 4 respectively. Consequently, the pixel electrode 3 and 4 do not receive an influence from the data line 9, but receive an influence from the electrostatic shielding layers 21 and 22 respectively. When the potentials of the electrostatic shielding layers 21 and 22 are large different from a variation range of the pixel electrodes 3 and 4 respectively, the influence of the electrostatic shielding layers 21 and 22 in the vicinity of the ends of the pixel electrodes 3 and 4 cannot be disregarded. A generation of an after-image degrades the screen display quality.

In the liquid-crystal display according to the second embodiment, the electrostatic shielding layers 21 and 22 are connected to the potential supply line 23, thereby to adjust the potential of the potential supply line 23. Based on this, the potentials of the electrostatic shielding layers 21 and 22 are set substantially equivalent to the center value of the potentials of the pixel electrodes 3 and 4. Specifically, in the liquid-crystal display according to the second embodiment, the potentials of the electrostatic shielding layers 21 and 22 are suppressed to within the variation range of the potentials of the pixel electrodes 3 and 4, thereby to eliminate the influence applied to the potentials of the pixel electrode 3 and 4. As an alternative, the potentials of the electrostatic shielding layers 21 and 22 may be set substantially equivalent to the potential of a common electrode disposed on the surface of a counter substrate that is disposed opposite to the TFT array substrate with a predetermined distance therebetween. It is also possible to set the potentials of the electrostatic shielding layers 21 and 22 to other values. As explained above, by connecting the electrostatic shielding layers 21 and 22 to the potential supply line 23, it is possible to suppress the influence that the electrostatic shielding layers 21 and 22 give to the pixel electrodes.

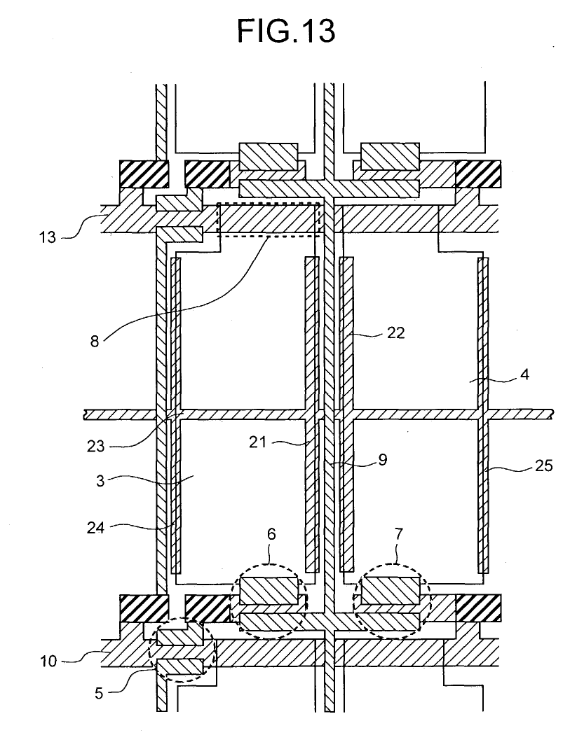

A modification of the liquid-crystal display according to the second embodiment will be explained next. FIG. 13 is a top plan view of a TFT array substrate in the liquid-crystal display according to this modification. Like in the first modification of the first embodiment, capacitor lines 24 and 25 are disposed in end-portion areas of the pixel electrodes 3 and 4 that face the areas in which the electrostatic shielding layers 21 and 22 are disposed. The capacitor lines 24 and 25 are connected to the potential supply line 23, and are connected to the electrostatic shielding layers 21 and 22 via the potential supply line 23. Based on this structure, like in the first modification of the first embodiment, even when an error occurs in the positioning of the mask pattern at the manufacturing time, the storage capacitors of the pixel electrodes do not change. As a result, it is possible to prevent the occurrence of degradation in the screen display quality.

While the present invention has been explained using two embodiments, the present invention is not limited to these embodiments and their modifications. A person skilled in the art could easily conceive of various embodiments and modifications based on the above embodiments. For example, the wiring structures of the pixel electrodes and thin-film transistors that are disposed on the TFT array substrate is not limited to that shown in, for example, FIG. 4. It is also possible to widely apply the present invention to a general image display that has a multiplexed image structure. Therefore, it is possible to realize a liquid-crystal display and the like that output a high-definition image by providing electrostatic shielding layers on the liquid-crystal displays that have a multiplex image structure described in Japanese Patent Application Laid-open Publication No. 5-265045, Japanese Patent Application Laid-open Publication No. 11-2837, Japanese Patent Application Laid-open Publication No. 5-303114, Japanese Patent Application Laid-open Publication No. 5-188395, and Japanese Patent Application Laid-open Publication No. 2000-373599. For example, Japanese Patent Application Laid-open Publication No. 2000-373599 describes about an image display that has a structure that a first thin-film transistor and a second thin-film transistor are connected to pixel electrodes via respective source/drain electrodes, and the gate electrodes of the first and second thin-film transistors are connected to predetermined scan lines respectively. When the electrostatic shielding layers explained above are disposed in this structure, it is possible to suppress the generation of a striped pattern.

The shapes and positions of disposing the electrostatic shielding layers are not limited to those shown in FIG. 3 and FIG. 11 unless it is possible to prevent the electric field generated from the data lines from affecting the potentials of the pixel electrodes. A person skilled in the art can freely design the shapes and the positions of disposing the electrostatic shielding layers by considering the influence applied to other characteristics and the manufacturing cost. For example, in FIG. 3, the electrostatic shielding layer 11 and the electrostatic shielding layer 12 may be integrated together. The integrated structure and the electrostatic shielding layer 16 shown in FIG. 11 may be combined to cover the whole surrounding of the data line 9.

Further, in the present invention, the structure of pixel electrodes to which a data line supplies potentials is not limited to only the one that the pixel electrodes are adjacently disposed to sandwich the data line. It is also possible that the data line that supplies potentials and the pixel electrodes are disposed in isolation. Even in this case, it is possible to dispose an electrostatic shielding layer between the pixel electrodes and the adjacent data line, thereby to prevent the pixel electrode from being affected by the potential variation of the data line. Consequently, it is possible to display a high-definition image. Further, the number of pixel electrodes to which potentials are supplied from the same data line is not limited to two. It is also possible to apply the present invention to each data line when the number of pixel electrodes is more than two.

As explained above, according to one aspect of the present invention, the first and second electrostatic shielding layers are provided. Therefore, it is possible to suppress or prevent potential variation of a data line near pixel electrodes from affecting these pixel electrodes. Even when a potential variation is different for each data line, it is possible to suppress the degradation of screen display quality such as a striped pattern, and there is an effect that it is possible to carry out a high-definition image display.

The first electrostatic shielding layer and the second electrostatic shielding layer have an equal potential. Therefore, the influence that the first electrostatic shielding layer gives to the first pixel electrode becomes equal to the influence that the second electrostatic shielding layer gives to the second pixel electrode. As a result, there is an effect that it is possible to suppress the degradation of the screen display quality.

According to still another aspect of the present invention, there is an effect that it is possible to prevent degradation of the image definition attributable to a difference between the effective potential of the electrostatic shielding layer and the effective potential of the pixel electrode, by setting the potential of the electrostatic shielding layer to substantially equivalent to the center value of the potential of the pixel electrode.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An image display element comprising:
a plurality of data lines that supply display signals;
a plurality of scan lines that supply scan signals;
a first pixel electrode and a second pixel electrode that are supplied with display signals from one data line;
a first electrostatic shielding unit that shields the first pixel electrode from an electric field produced by a data line that is adjacent to the first pixel electrode; and
a second electrostatic shielding unit that shields the second pixel electrode from an electric field produced by a data line that is adjacent to the second pixel electrode.

2. The image display element according to claim 1, further comprising:
a first switching device that controls a supply of the display signal in the one data line, wherein the first switching device is electrically connected between the one data line and the first pixel electrode and has a gate electrode;
a second switching device that is electrically connected between the gate electrode of the first switching device and a predetermined scan line; and
a third switching device that is connected to the one data line and that controls a supply of the display signal to the second pixel electrode.

3. The image display element according to claim 1, wherein
the first electrostatic shielding unit is formed by a first conductive layer that is disposed adjacent to the data line in a lower layer than the first pixel electrode, and
the second electrostatic shielding unit is formed by a second conductive layer that is disposed adjacent to the data line in the lower layer than the second pixel electrode.

4. The image display element according to claim 1, wherein
the first electrostatic shielding unit and the first pixel electrode have areas that are partially superimposed with each other in a direction that is perpendicular to the surface of layers, and
the second electrostatic shielding unit and the second pixel electrode have areas that are partially superimposed with each other in the direction that is perpendicular to the surface of layers.

5. The image display element according to claim 4, further comprising:
a first capacitor line that is disposed in an area partially superimposed with the first pixel electrode in the direction that is perpendicular to the surface of layers in the peripheral lower layer of the first pixel electrode facing the area in which the first electrostatic shielding unit is disposed, and that is connected to the first electrostatic shielding unit; and
a second capacitor line that is disposed in an area partially superimposed with the second pixel electrode in the direction that is perpendicular to the surface of layers in the peripheral lower layer of the second pixel electrode facing the area in which the second electrostatic shielding unit is disposed, and that is connected to the second electrostatic shielding unit.

6. The image display element according to claim 1, wherein the first electrostatic shielding unit and the second electrostatic shielding unit are electrically connected to each other.

7. The image display element according to claim 1, wherein
the first electrostatic shielding unit and the second electrostatic shielding unit are electrically connected to a wiring structure that has a predetermined potential.

8. The image display element according to claim 1, wherein
the first electrostatic shielding unit and the second electrostatic shielding unit are connected to a predetermined scan line.

9. The image display element according to claim 1, wherein the first electrostatic shielding unit and the second electrostatic shielding unit are connected to a potential supply line that has a predetermined potential.

10. The image display element according to claim 9, wherein the predetermined potential is maintained within a range of a potential variation of the pixel electrode.

11. The image display element according to claim 9, wherein the predetermined potential is maintained within a range of a potential variation of a common electrode that is disposed on a counter substrate disposed opposite to a substrate on which the pixel electrode is disposed with a predetermined distance between the substrates.

12. An image display device, comprising:
a data line driving circuit that supplies a display signal to a plurality of data lines;
a scan line driving circuit that supplies a scan signal to a plurality of scan lines;
a first pixel electrode and a second pixel electrode that are supplied with display signals from one data line;
a first electrostatic shielding unit that shields the first pixel electrode from an electric field produced by a data line that is adjacent to the first pixel electrode; and
a second electrostatic shielding unit that shields the second pixel electrode from an electric field produced by a data line that is adjacent to the second pixel electrode.

13. The image display device according to claim 12, further comprising:
a first switching device that controls a supply of the display signal in the one data line, wherein the first switching device is electrically connected with the one data line and the first pixel electrode and has a gate electrode;
a second switching device that is disposed between the gate electrode of the first switching device and a predetermined scan line; and
a third switching device that is connected to the one data line and that controls a supply of the display signal to the second pixel electrode.

14. The image display-device according to claim 12, wherein the first electrostatic shielding unit and the second electrostatic shielding unit are connected to a predetermined scan line.

15. The image display device according to claim 12, wherein the first electrostatic shielding unit and the second electrostatic shielding unit are connected to a potential supply line that has a predetermined potential.

16. The image display device according to claim 15, wherein the predetermined potential is maintained within a range of a potential variation of the pixel electrode.
